(19) United States
(12) Patent Application Publication
(10) Pub. No.: US 2014/0201781 A1
(43) Pub. Date: Jul. 17, 2014

(54) Enhanced TV News Delivery of an Amber Alert, Code Adam, Silver Alert, or Armed Robbery

(71) Applicant: Acilda Harrise Mason, Raleigh, NC (US)

(72) Inventor: Acilda Harrise Mason, Raleigh, NC (US)

(73) Assignee: Acilda Mason, Cary, NC (US)

(21) Appl. No.: 14/147,509

(22) Filed: Jan. 4, 2014

Related U.S. Application Data
(60) Provisional application No. 61/797,593, filed on Dec. 10, 2012.

(51) Int. Cl. H04N 21/488

(52) U.S. Cl. CPC H04N 21/4882
USPC 725/33

(57) ABSTRACT

Showing a picture of the make, model, year, and color of a vehicle that has been involved in a Silver Alert, or Code Adam, Amber Alert, or robbery will enable more citizens to recognize the vehicle than just announcing or printing a reporting a description of the car.

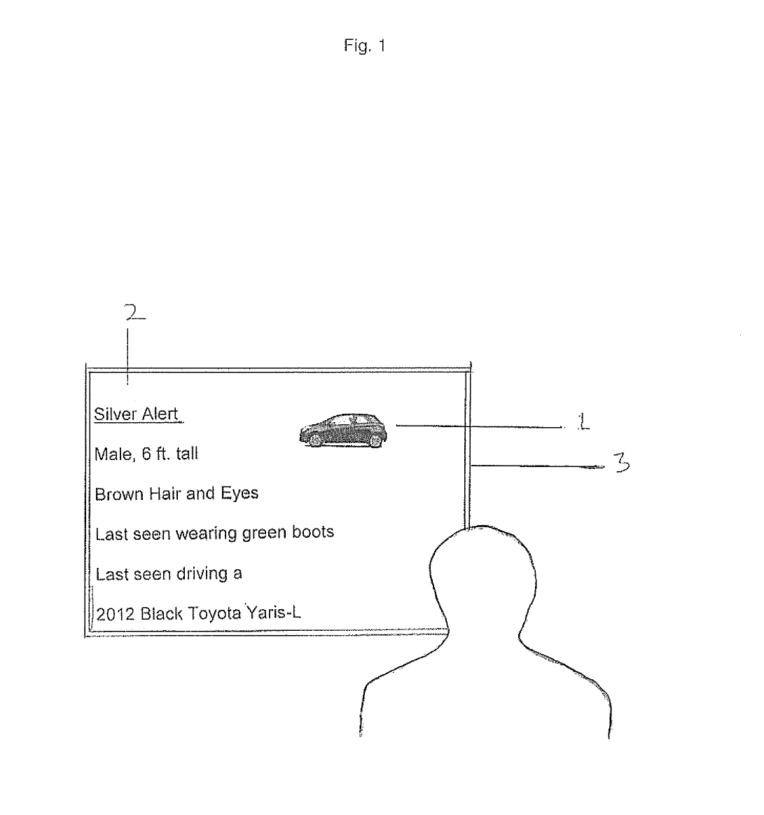

When the newsroom director needs to inform the public of an Amber Alert, Code Adam, Silver Alert, or Armed Robbery, a search engine will be used to locate and upload a picture of the vehicle that will be mentioned in the public alert. (Example: A 2012 Black Toyota Yaris-L) The picture of the car in the alert will serve as the logo on the over-the-shoulder (OTS) monitor, and will be visible to TV viewers as the newsperson gives further details of the event.

1. I wish to protect the concept of using a picture of the exact year, make, model, and color of any automobile that is related to an Amber Alert, Code Adam, Silver Alert, or any other crime that involves a motor vehicle will be included in the news report to enhance the written and verbal information that as offered to the public alert.
